(19) United States
(12) Patent Application Publication
(10) Pub. No.: US 2018/0122218 A1
(43) Pub. Date: May 3, 2018

(54) PROXIMITY ALARM SYSTEM AND METHOD OF OPERATING SAME

(71) Applicant: BRIAN SHANLEY, Dungarvan (IE)

(72) Inventor: BRIAN SHANLEY, Dungarvan (IE)

(21) Appl. No.: 15/337,792

(22) Filed: Oct. 28, 2016

(51) Int. Cl. G08B 25/01; G08B 21/02

(52) U.S. Cl. CPC G08B 25/016; G08B 21/02

(57) ABSTRACT

This invention relates to a proximity alarm system for a worker operating in the vicinity of a moving machine and a method of operating such a system. The proximity alarm system comprises a machine unit for mounting on the moving machine and a worker unit configured to be carried about the person of the worker. The machine unit comprises a boundary field generator for generating an electric field that extends outwardly from the machine. The worker unit comprises an electric field pick-up sensor for detection of the electric field and a worker alarm unit comprising, for example, an audible alarm. The worker alarm unit is actuated in response to the electric field pick-up sensor detecting the electric field, thereby alerting the worker to the proximity of the moving machine.

### FIELD OF THE INVENTION

This invention relates to a proximity alarm system for a worker operating in the vicinity of a moving machine and a method of operating such a proximity alarm system.

### BACKGROUND OF THE INVENTION

Working in the vicinity of moving machines such as excavators, earth moving machinery and earth moving trucks can be very dangerous. A momentary lapse in concentration can result in a life-changing or even life-ending accident. Unfortunately, it is all too common for a worker to inadvertently wander into the path of an approaching moving machine or to encroach into the working area of an excavator arm or a back actor, often with disastrous consequences. Of particular concern are those areas not in the machine operator's line of sight. In 2010, 60% of all construction work related deaths in Ireland involved vehicles.

Various measures have been proposed to address the dangers of working in the vicinity of moving machines. Heretofore, these measures have focused on better, more extensive training of workers. By educating the workers of the potential dangers of working on a construction site or elsewhere in the vicinity of moving machinery, it is possible to reduce the incidences of accidents involving machinery. However, accidents are still far too frequent. Other measures entail the provision of safety clothing to each of the workers such as high visibility jackets. Although these measures may make the worker more visible to the operators of the moving machines and therefore less likely to be harmed due to operator error, they do not in any way help to reduce the likelihood of the worker themselves wandering into the path of an approaching moving machine.

It is an object of the present invention to provide a proximity alarm system and a method of operating a proximity alarm system that addresses at least some of the above-identified problems. It is a further object of the present invention to provide a proximity alarm system and method of operating same that helps to reduce the likelihood of a worker wandering into the path of a moving machine.

### SUMMARY OF THE INVENTION

According to the invention there is provided a proximity alarm system for a worker operating in the vicinity of a moving machine, the proximity alarm system comprising a machine unit for mounting on the moving machine and a worker unit configured to be carried about the person of the worker; the machine unit comprising a boundary field generator for generating an electric field emanating outwardly from the machine; the worker unit comprising an electric field pick-up sensor for detection of the electric field, a power supply, a worker alarm unit, and a microcontroller in communication with the electric field pick-up sensor and the worker alarm unit and operable to actuate the worker alarm unit in response to the electric field pick-up sensor detecting the electric field, thereby alerting the worker to the proximity of the moving machine.

By having such a proximity alarm system, when the worker gets within a predetermined distance of the moving machine, which may be, for example, an excavator or an earth moving truck, an alarm unit on the worker's person will be activated. The alarm unit thereby warns the worker of the imminent danger. The worker, on being alerted to the danger, can then take corrective or evasive action and move away from the moving machine.

In one embodiment of the invention there is provided a proximity alarm system in which the worker unit further comprises a worker unit communications module. By having a worker unit communications module, the worker unit can transmit a report of the incident to a remote location and/or can transmit an alert to another location warning another worker such as the operator of the moving machine of the imminent danger to his colleague. Alternatively, if an alert is transmitted, this may be used to control the moving machine. Finally, by having a worker unit communications module, this will allow the worker unit to be configured remotely.

In one embodiment of the invention there is provided a proximity alarm system in which the machine unit further comprises a machine unit communications module, a machine alarm unit and a machine unit controller in communication with the machine unit communications module and the machine alarm unit and operable to actuate the machine alarm unit in response to the machine unit communications module receiving a machine alarm unit activation instruction. In this way, if the machine unit receives an alarm unit activation instruction, the machine unit can signal an alarm on the machine. This will further help to alert the worker of the danger and also will potentially help to alert an operator of the moving machine of the threat to a worker's safety.

In one embodiment of the invention there is provided a proximity alarm system in which there is provided a logger unit having an accessible memory and a logger communications module configured for communication with at least one of the machine unit communications module and the worker unit communications module. This is seen as a useful embodiment of the present invention. By having a logger unit with accessible memory, it will be possible to keep a record of the alarm conditions over time as well as a record of the individual machine and worker units, their settings and which machines or workers those individual units relate to.

In one embodiment of the invention there is provided a proximity alarm system in which the boundary field generator is configured to generate an electric field that surrounds the moving machine. This is seen as particularly effective for moving vehicles such as diggers and trucks that can move in a very wide range of directions and may have workers approaching them from a plethora of disparate directions.

In one embodiment of the invention there is provided a proximity alarm system in which the boundary field generator comprises a wire loop circumnavigating the moving machine and a pulse generator for delivering low frequency energy pulses through the wire loop. This is seen as a simple and inexpensive way of providing the electric field that surrounds the moving machine. Furthermore, by having a wire loop, it will be possible to detect with relative ease if there is a break in the wire loop (i.e. an open circuit) and that the system is not operating as desired. An operator can be alerted to the malfunction (for example by sounding a machine alarm if an open circuit is detected) and the operator can take appropriate action. The wire loop may be provided in a protective rubber casing to obviate the likelihood of the wire being damaged during use.

In one embodiment of the invention there is provided a proximity alarm system in which the wire loop is mounted on the moving machine substantially horizontal with respect to the ground. By having the wire substantially horizontal, this will help to ensure that the electric field emanates a relatively uniform distance from the moving vehicle around the circumference of the moving vehicle.

In one embodiment of the invention there is provided a proximity alarm system in which the wire loop is arranged at least 5 feet above the ground. Ideally, the wire loop will be positioned at approximately head height as this will interact well if the worker units are located on the worker's hard hat.

In one embodiment of the invention there is provided a proximity alarm system in which the boundary field generator comprises an RFID reader. This is seen as a suitable alternative to the use of a wire and a pulse generator. By having an RFID reader, the RFID reader can emit an electromagnetic field that can be picked up by nearby RFID transponders in the worker units worn by the workers. This will greatly simplify installation of the machine unit. As an alternative to RFID, the boundary field generator may comprise a radio transmitter or transceiver and the electric field pick-up sensor for detection of the electric field may comprise a radio receiver or transceiver.

In one embodiment of the invention there is provided a proximity alarm system in which the RFID reader is mounted centrally on the moving machine. In this way, the field emanating from the machine unit will be in a relatively uniform radius surrounding the vehicle.

In one embodiment of the invention there is provided a proximity alarm system in which the boundary field generator comprises a plurality of beacons circumferentially spaced apart from each other about the periphery of the moving machine. The beacons could be RFID readers with reduced range if desired. Instead of placing a single RFID reader centrally on the moving machine which may suffer from interference and uneven field strength, or a wire that must circumnavigate the entire moving machine which may be problematic to install and maintain, it is envisaged that a number of transmitting beacons could be provided about the vehicle, such as, but not limited to, one or more either side of the moving machine. In this way, it will also be possible to detect the location of a worker as the beacon that detects the worker will also be indicative of the workers position relative to the moving machine.

In one embodiment of the invention there is provided a proximity alarm system in which there is provided a visual display mounted in a driver's cab of the moving machine for displaying the location of a worker working in the vicinity of the moving machine. If it is possible to detect the workers position vis-a-vis the moving machine, it is possible to accurately display the workers position on a monitor or other graphical user interface. This can assist the operator of the moving machine to help avoid an accident. It is important however that such an implementation is not provided in such a way that it would distract a driver and detract from their primary focus of safe machine operation.

In one embodiment of the invention there is provided a proximity alarm system in which the moving machine comprises one of an earth-moving machine, a goods transporting vehicle, or an item of farm machinery. The present invention is deemed particularly suitable for use with these machines. Alternatively, the machine could be only partially moveable, such as a crane that has a stationary mast and a moveable boom. As a further still alternative, the machine could be a cutting machine or other like machine that is stationary but has moving parts that could cause injury to a worker if they were to come into contact with those moving parts. The system and method of the present invention may have very useful application around a power take off (PTO) of a piece of farm machinery or a tractor.

In one embodiment of the invention there is provided a proximity alarm system in which the worker unit is provided with a mounting bracket for mounting the worker unit on a hard hat. This is seen as a particularly effective and useful embodiment of the present invention. The hard hat is a piece of equipment that is mandatory on practically all construction sites and will therefore provide a useful mounting position that is uniform on all workers on the site, irrespective of clothing or gender.

In one embodiment of the invention there is provided a proximity alarm system in which the worker unit is provided with a mounting bracket for mounting the worker unit on one of a belt or a strap.

In one embodiment of the invention there is provided a proximity alarm system in which the range of the electric field pick-up sensor is adjustable. This is seen as beneficial as different workers may be allowed to get closer than others to certain machinery. For example, individuals working with a tarmacadam truck may be allowed to get within 2 metres of the truck whereas others may signal an alarm if they are 5 metres away.

In one embodiment of the invention there is provided a proximity alarm system in which the worker alarm unit comprises an audible alarm.

In one embodiment of the invention there is provided a proximity alarm system in which the machine alarm unit comprises an audible alarm.

In one embodiment of the invention there is provided a proximity alarm system in which the audible alarm is provided by way of an audible alarm of the moving machine. For example, the horn (if provided) of the moving machine may be used as the audible alarm. This can be distinctive and loud and will not require additional audible alarm equipment, thereby reducing the cost of the system.

In one embodiment of the invention there is provided a proximity alarm system in which the machine alarm unit comprises a visual alarm. The visual alarm may for example be a flashing light and/or a coloured light.

In one embodiment of the invention there is provided a proximity alarm system in which the machine unit is provided with a power supply connector for connection to the power supply of the moving machine. In this way, a separate power source will not have to be provided and the machine's battery can be used to operate the machine unit.

In one embodiment of the invention there is provided a proximity alarm system in which the machine unit is in communication with a control unit of the moving machine and the machine unit controller is operable to temporarily disable, at least in part, the moving machine. For example, the engine of the machine or a back-actor or the like could be temporarily disabled, thereby effectively freezing the machine in the event of a dangerous situation being detected. Of course, care will have to be taken to analyse the safety consequences of freezing or disabling certain equipment suddenly and how it can be achieved without dropping a load or causing another dangerous situation.

In one embodiment of the invention there is provided a proximity alarm system in which the microcontroller is operable to actuate the worker alarm unit in accordance with the strength of the electric field detected by the electric field pick-up sensor. This is seen as another useful alternative embodiment of the invention. For example, if the worker alarm unit comprises an audible alarm, the microcontroller may be operable to alter one or more of the pitch, the frequency or the volume of the audible alarm to vary with the strength of the sensed electric field and by extension with the proximity of the moving machine. As the moving machine gets closer, the sound from the audible alarm may get louder, faster or higher pitched.

In one embodiment of the invention there is provided a proximity alarm system in which the electric field comprises an electromagnetic field.

In one embodiment of the invention there is provided a proximity alarm system in which each worker unit is provided with a unique identifier. By providing each worker unit with a unique identifier, it will be possible to monitor a workers performance and the number of incidences that that worker was involved in over the course of a shift or another longer period of time.

In one embodiment of the invention there is provided a method of operating a proximity alarm system for a worker operating in the vicinity of a moving machine comprising the steps of: mounting a machine unit on the moving machine and providing the worker with a worker unit configured to be carried about their person; using the machine unit, generating an electric field emanating outwardly from the machine; using the worker unit, detecting the electric field emanating outwardly from the moving machine with an electric field pick-up sensor of the worker unit, and on the electric field pick-up sensor detecting the electric field, alerting the worker to the proximity of the moving machine by actuating a worker alarm unit of the worker unit.

By having such a method, the worker will be alerted to the fact that they are coming into close proximity to a moving machine and that they are potentially in danger. This will help to avoid an accident in the event of a worker inadvertently encroaching on a moving machine.

In one embodiment of the invention there is provided a method of operating a proximity alarm system for a worker operating in the vicinity of a moving machine comprising the additional steps of, in addition to the worker unit actuating a worker alarm unit of the worker unit, the worker unit transmitting a machine alarm unit activation instruction to the machine unit and the machine unit actuating a machine alarm unit.

In one embodiment of the invention there is provided a method of operating a proximity alarm system for a worker operating in the vicinity of a moving machine in which the step of actuating a worker alarm unit of the worker unit comprises signalling an audible alarm.

### BRIEF DESCRIPTION OF THE DRAWINGS

The invention will now be more clearly understood from the following description of some embodiments thereof given by way of example only with reference to the accompanying drawings, in which:

FIG. 1 is a diagrammatic representation of a construction site in which the method and system according to the invention may be implemented;

FIG. 2 is a diagrammatic representation of an earth moving truck with a machine unit according to the invention installed thereon;

FIG. 3 is a diagrammatic representation of one embodiment of a proximity alarm system according to the invention;

FIG. 4 is a diagrammatic representation of another embodiment of a proximity alarm system according to the invention;

FIG. 5 is a front perspective view of a worker unit according to the invention;

FIG. 6 is a rear perspective view of a worker unit according to the invention;

FIG. 7 is a perspective view of a clip for a worker unit;

FIG. 8 is a perspective view of the worker unit mounted on a hard hat;

FIG. 9 is a perspective view of the worker unit mounted on a belt;

FIG. 10 is a front view of a logger unit according to the invention;

FIG. 11 is a front view of a logger unit communicating with a worker unit;

FIG. 12 is a front perspective view of a machine unit according to the invention; and

FIG. 13 is a rear perspective view of the machine unit according to the invention.

### DESCRIPTION OF THE EXEMPLARY EMBODIMENTS

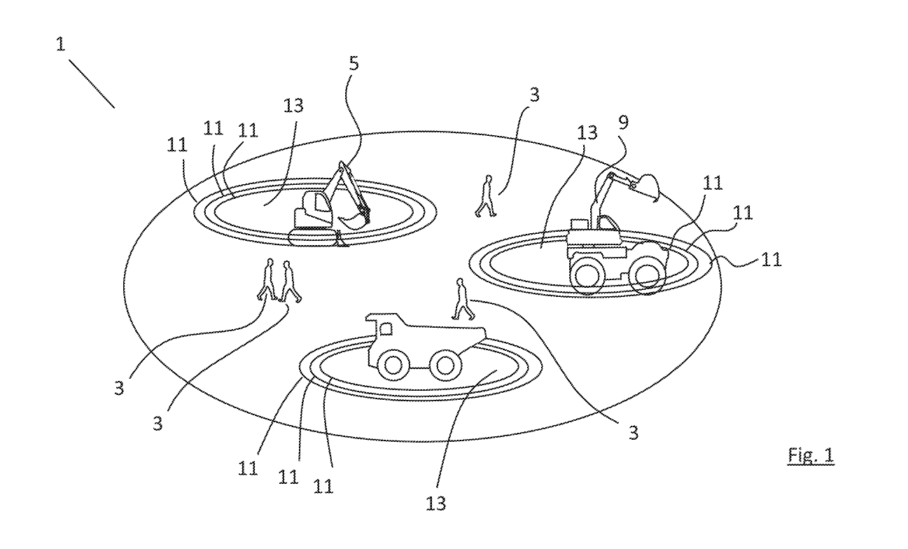

Referring to FIG. 1, there is shown a diagrammatic representation of a construction site in which the method and system according to the invention may be implemented, indicated generally by the reference numeral 1. The construction site comprises a plurality of workers 3 and a plurality of moving machines including an excavator 5, an earth moving truck 7 and a load carrying vehicle 9 of the type used to transport pallets around a construction site. Each of the moving machines 5, 7, 9 is surrounded by a plurality of concentric circles 11 indicating the exclusion zone 13 surrounding the moving machine. This exclusion zone 13 is an area where a worker 3 should not stray as by doing so, they risk serious injury. For example, if a worker enters the exclusion zone 13 surrounding the excavator 5, they run the risk of being hit by the digging arm as it rotates about the excavator in the known manner. A purpose of the present invention is to provide a proximity alarm system that alerts a worker when they stray into an exclusion zone 13.

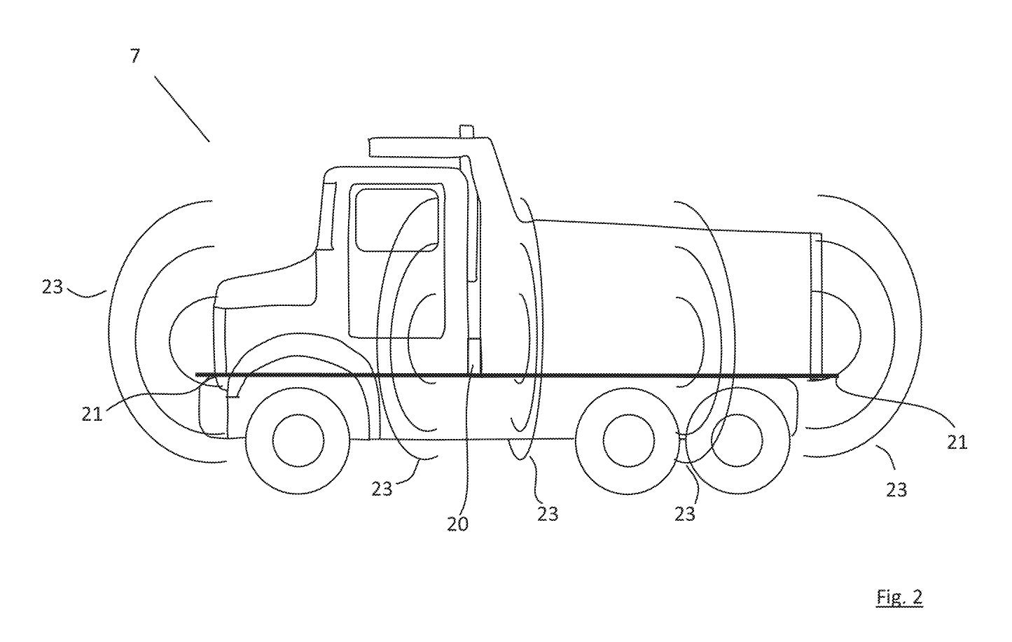

Referring now to FIG. 2, there is shown a diagrammatic representation of an earth moving truck 7 with a machine unit 20 (only parts of which are shown) according to the invention installed thereon. The machine unit comprises a wire 21 mounted on the truck and surrounding the truck. The wire 21 is substantially horizontal and is placed at approximately an average head height of a worker standing on the ground in the vicinity of the truck. For example, in the embodiment shown, the wire is mounted at approximately five feet above ground level.

The machine unit comprises a boundary field generator (not shown) that comprises circuitry for generating a low frequency energy pulse that is delivered along the wire 21. This low frequency energy pulse generates an electric field, represented graphically in the figure by curved lines 23. The electric field emanates outwardly from the wire 21 and surrounds the earth moving truck 7, creating an exclusion zone around the truck.

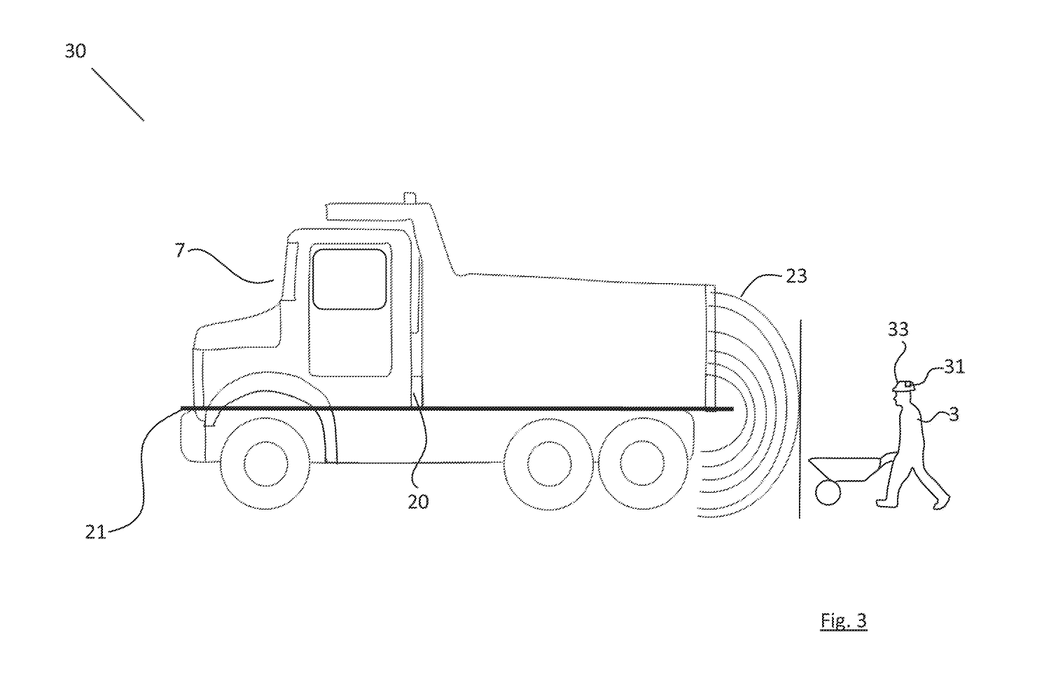

Referring now to FIG. 3, there is shown a diagrammatic representation of one embodiment of a proximity alarm system according to the invention, indicated generally by the reference numeral 30, where like parts have been given the same reference numeral as before. The proximity alarm system 30 comprises a machine unit 20 including a wire 21 and a boundary field generator (not shown) comprising circuitry for generating a low frequency energy pulse that is delivered along the wire 21. This low frequency energy pulse generates an electric field 23. The proximity alarm system further comprises a worker unit 31 carried by the worker 3. In this case, the worker unit 31 is mounted on a hard hat 33 worn by the worker. The worker unit comprises an electric field pick-up sensor (not shown) for detection of the electric field, a power supply (not shown), a worker alarm unit (not shown), and a microcontroller (not shown) in communication with the electric field pick-up sensor and the worker alarm unit. The microcontroller is operable to actuate the worker alarm unit in response to the electric field pick-up sensor detecting the electric field 23. The alarm unit may comprise an audible alarm such as, but not limited strictly to, a buzzer. In this way, the worker is alerted to the proximity of the moving machine 7. In the embodiment shown, it will be understood that the worker is facing the moving machine 7 however typically, they may have their back to the moving machine or the moving machine may be obscured from view and therefore the moving machine may not be in their direct line of sight.

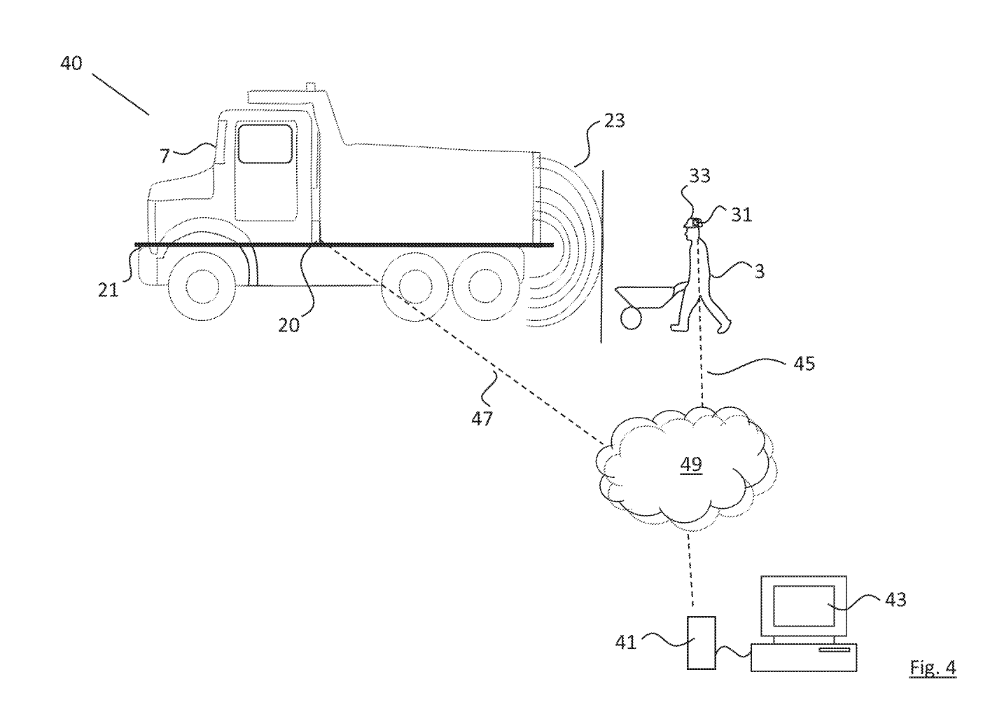

Referring now to FIG. 4, there is shown a diagrammatic representation of another embodiment of a proximity alarm system according to the invention, indicated generally by the reference numeral 40, where like parts have been given the same reference numerals as before. The proximity alarm system 40 further comprises a logger unit 41 connected to a personal computer 43. The logger unit is in communication with the worker unit 31 and the machine unit 20 over communication channels 45, 47 respectively through a communication network 49, in this instance the internet.

It is envisaged that both the worker unit 31 and the machine unit 20 will have communication modules therein providing access to the internet. For example, the worker unit and/or the machine unit may have Global System for Mobile Communications (GSM) modules therein or WiFi modules that allow access to a communication network and from there to the internet where the logger unit may be accessed. Data relating to alarm events may be uploaded to the logger unit 41 and the PC 43 and its graphical user interface (GUI) may be used to analyse the data. For example, a workers performance over the course of a shift or term of employment may be analysed. If the worker is generating a significant number of alarms, appropriate investigations and action can be taken to address the large number of alarms involving the worker.

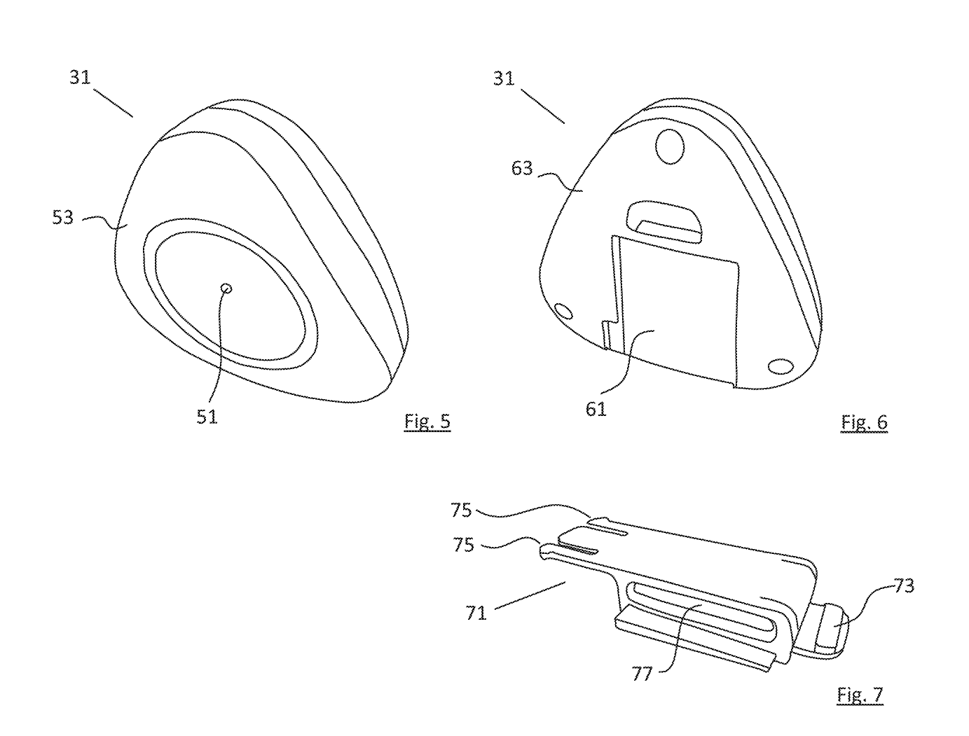

Referring to FIGS. 5 and 6, there are shown various perspective views of a worker unit 31 according to the invention. The worker unit 31 comprises a channel 61 in the rear surface 63 thereof (as illustrated in FIG. 6) for reception of a clip. An antenna is mounted inside the housing along with the microcontroller, the power supply, the electric field pick-up sensor for detection of the electric field and the worker alarm unit. An LED 51 is provided in the front surface 53 of the worker unit casing.

Referring to FIG. 7, there is shown a perspective view of a clip 71 for insertion into the channel 61 in the rear surface 63 of the worker unit 31. The clip 73 comprises a first boss for engagement of a complementary groove in the rear surface of the worker unit to hold the clip in position relative to the worker unit 31. The clip further comprises a pair of spring loaded arms 75 for engagement with a universal connection aperture (not shown) in a hard hat so that the worker unit may be mounted on a hard hat. The clip also includes a through-channel 77 for reception of a belt or a strap so that the clip 71 and in turn a worker unit 31 connected thereto may be mounted on a belt (not shown) or strap (not shown) worn by a worker.

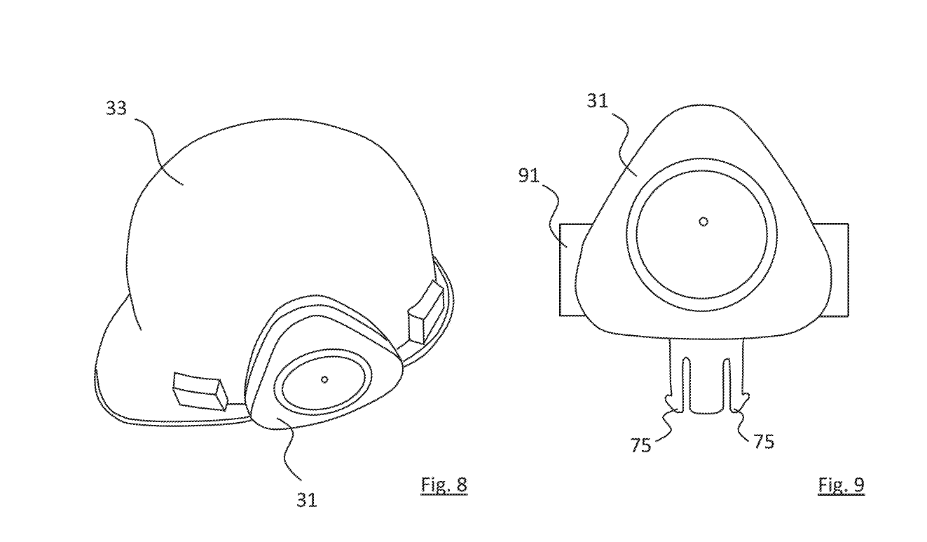

Referring to FIG. 8, there is shown a perspective view of the worker unit 31 mounted on a hard hat 33. Referring to FIG. 9, there is shown a perspective view of the worker unit 31 mounted on a belt 91.

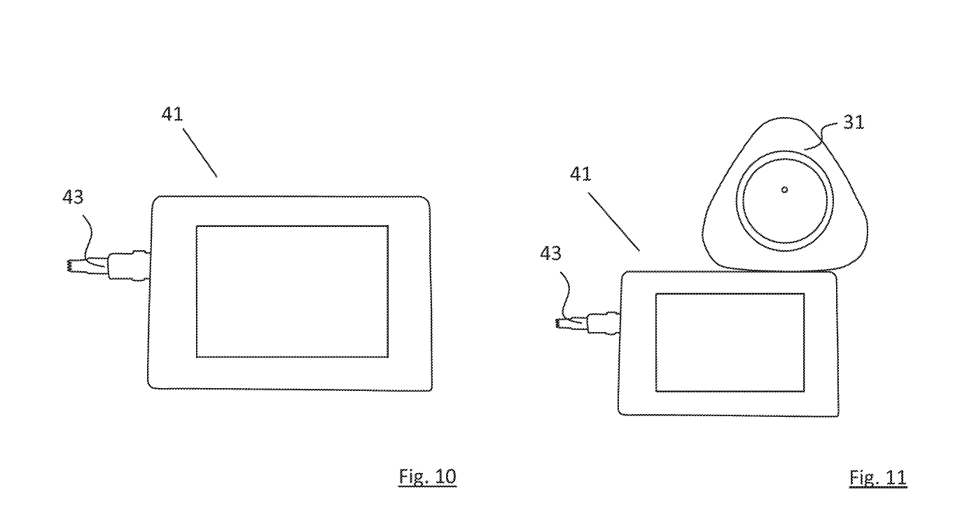

Referring to FIG. 10, there is shown a front view of a logger unit 41 including power cable 43 connected thereto. Referring to FIG. 11, there is shown a further front view of the logger unit in close proximity to a worker unit 31. It is envisaged that the logger unit 41 and the worker unit 31 may be configured to communicate with each other over short range, low power communications such as Bluetooth ®, Zigbee ® or the like. In this way, the logger unit 41 can be used to update the information on the worker unit 31 and/or the data on the worker unit can be downloaded onto the logger unit for subsequent analysis on a PC or other computing device (not shown). It is envisaged that the logger unit may also communicate with a machine unit 20 in much the same way.

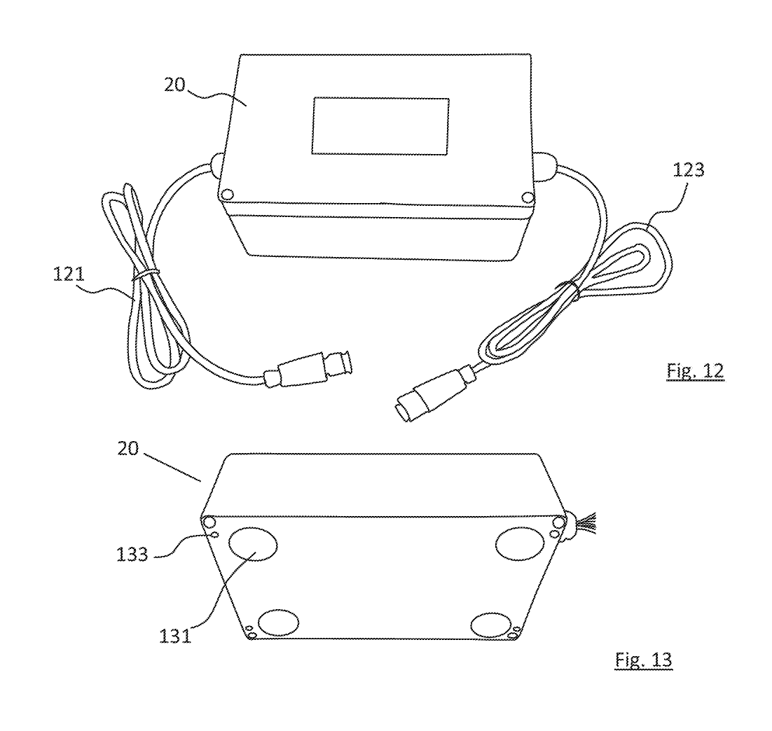

Referring now to FIGS. 12 and 13, there are shown perspective views of a machine unit 20 according to the invention. In FIG. 12, the machine unit 20 is shown with a power cable 121 on the left hand side of the unit and an alarm unit cable 123 on the right hand side. The power cable 121 comprises a four way female connector with connections for both terminals of a DC supply and connections for both ends of a wire (not shown) for delivery of electrical pulses down the wire. The alarm unit cable 23 connects the normally open volt free relay contacts (not shown) internal the machine unit 20. These contacts will close and open once a second to complete a circuit in the event of an alarm being generated in order to trigger a horn (e.g. of the moving machine if it is a vehicle) or other warning hazard indicator such as a coloured, flashing (or other) light. The relay contacts may also open in the event of the wire loop becoming open circuited to alert a user that the system is effectively inoperable and malfunctioning.

FIG. 13 is a rear perspective view of the machine unit according to the invention. The machine unit 20 comprises a plurality of magnets 131 for securing the machine unit 20 to a machine. The machine unit 20 further comprises a plurality of blind screw holes 133 that may be punched through with screws for mounting the machine unit on a machine. This might be preferable in hostile environments or where the machine unit will be subjected to shocks or impacts.

It will be understood that one aspect of the present invention will be to allow a number of reports to be generated that can be analysed. Furthermore, there will preferably be provided a database with identifiers and data relating to the machine units and the worker units therein. This database can be written to, modified and updated to add new units, delete old units and update information on the units such as the detection range of the worker units. An operator may use a PC and the GUI of the PC to inspect the data and ensure that it is in order.

Throughout this specification, reference is made to a moving machine and operation of the system on a construction site. However, it will be understood that the moving machine is not necessarily a vehicle unless specifically so limited by the claims. The moving machine may be a machine with moving parts such as a press or a saw that could have the field generation equipment to alert a worker when they are getting close to the machine. Furthermore, the invention is not limited to operation on a construction site and it is envisaged that the invention could be used in other environments such as, but not limited to a farm environment or a warehouse. For example, in the warehouse, the forklifts could be provided with the field generation means and the workers could carry worker units as appropriate.

In this specification the terms “comprise, comprises, comprised and comprising” and the terms “include, includes, included and including” are all deemed totally interchangeable and should be afforded the widest possible interpretation.

The invention is not solely limited to the embodiments hereinbefore described but may be varied in both construction and detail within the scope of the appended claims.

What is claimed is:

1. A proximity alarm system for a worker operating in the vicinity of a moving machine, the proximity alarm system comprising a machine unit for mounting on the moving machine and a worker unit configured to be carried about the person of the worker; the machine unit comprising a boundary field generator for generating an electric field emanating outwardly from the machine; the worker unit comprising an electric field pick-up sensor for detection of the electric field, a power supply, a worker alarm unit, and a microcontroller in communication with the electric field pick-up sensor and the worker alarm unit and operable to actuate the worker alarm unit in response to the electric field pick-up sensor detecting the electric field, thereby alerting the worker to the proximity of the moving machine.

2. The proximity alarm system as claimed in claim 1 in which the worker unit further comprises a worker unit communications module.

3. The proximity alarm system as claimed in claim 2 in which the machine unit further comprises a machine unit communications module, a machine alarm unit and a machine unit controller in communication with the machine unit communications module and the machine alarm unit and operable to actuate the machine alarm unit in response to the machine unit communications module receiving a machine alarm unit activation instruction.

4. The proximity alarm system as claimed in claim 3 in which there is provided a logger unit having an accessible memory and a logger communications module configured for communication with at least one of the machine unit communications module and the worker unit communications module.

5. The proximity alarm system as claimed in claim 1 in which the boundary field generator is configured to generate an electric field that surrounds the moving machine.

6. The proximity alarm system as claimed in claim 5 in which the boundary field generator comprises a wire loop circumnavigating the moving machine and a pulse generator for delivering low frequency energy pulses through the wire loop.

7. The proximity alarm system as claimed in claim 6 in which the wire loop is mounted on the moving machine substantially horizontal with respect to the ground.

8. The proximity alarm system as claimed in claim 6 or 7 in which the wire loop is arranged at least 5 feet above the ground.

9. The proximity alarm system as claimed in claim 5 in which the boundary field generator comprises an RFID reader.

10. The proximity alarm system as claimed in claim 9 in which the RFID reader is mounted centrally on the moving machine.

11. The proximity alarm system as claimed in claim 5 in which the boundary field generator comprises a plurality of beacons circumferentially spaced apart from each other about the periphery of the moving machine.

12. The proximity alarm system as claimed in claim 11 in which there is provided a visual display mounted in a driver's cab of the moving machine for displaying the location of a worker working in the vicinity of the moving machine.

13. The proximity alarm system as claimed in claim 1 in which the moving machine comprises one of an earth-moving machine, a goods transporting vehicle, or an item of farm machinery.

14. The proximity alarm system as claimed in claim 1 in which the worker unit is provided with a mounting bracket for mounting the worker unit on a hard hat.

15. The proximity alarm system as claimed in claim 1 in which the worker unit is provided with a mounting bracket for mounting the worker unit on one of a belt or a strap.

16. The proximity alarm system as claimed in claim 1 in which the range of the electric field pick-up sensor is adjustable.

17. The proximity alarm system as claimed in claim 1 in which the worker alarm unit comprises an audible alarm.

18. The proximity alarm system as claimed in claim 3 in which the machine alarm unit comprises an audible alarm.

19. The proximity alarm system as claimed in claim 18 in which the audible alarm is provided by way of an audible alarm of the moving machine.

20. The proximity alarm system as claimed in claim 18 in which the machine alarm unit comprises a visual alarm.

21. The proximity alarm system as claimed in claim in claim 1 in which the machine unit is provided with a power supply connector for connection to the power supply of the moving machine.

22. The proximity alarm system as claimed in claim 3 in which the machine unit is in communication with a control unit of the moving machine and the machine unit controller is operable to temporarily disable, at least in part, the moving machine.

23. The proximity alarm system as claimed in claim 1 in which the microcontroller is operable to actuate the worker alarm unit in accordance with the strength of the electric field detected by the electric field pick-up sensor.

24. The proximity alarm system as claimed in claim 1 in which the electric field comprises an electromagnetic field.

25. The proximity alarm system as claimed in claim 1 in which each worker unit is provided with a unique identifier.

26. A method of operating a proximity alarm system for a worker operating in the vicinity of a moving machine comprising the steps of: mounting a machine unit on the moving machine and providing the worker with a worker unit configured to be carried about their person; using the machine unit, generating an electric field emanating outwardly from the machine; using the worker unit, detecting the electric field emanating outwardly from the moving machine with an electric field pick-up sensor of the worker unit, and on the electric field pick-up sensor detecting the electric field, alerting the worker to the proximity of the moving machine by actuating a worker alarm unit of the worker unit.

27. A method of operating a proximity alarm system for a worker operating in the vicinity of a moving machine as claimed in claim 26 comprising the additional steps of, in addition to the worker unit actuating a worker alarm unit of the worker unit, the worker unit transmitting a machine alarm unit activation instruction to the machine unit and the machine unit actuating a machine alarm unit.

28. A method of operating a proximity alarm system for a worker operating in the vicinity of a moving machine as claimed in claim 26 in which the step of actuating a worker alarm unit of the worker unit comprises signaling an audible alarm.
